(19) United States
(12) Patent Application Publication
(10) Pub. No.: US 2026/0121886 A1
(43) Pub. Date: Apr. 30, 2026

(54) MULTI-BUS WIRELESS COMMUNICATION SYSTEM

(71) Applicant: Qorvo US, Inc., Greensboro, NC (US)

(72) Inventors: Kerry Cloyce Glover, Cross Roads, TX (US); Christopher Truong Ngo, Queen Creek, AZ (US); Ali Imran Bawangaonwala, Summerfield, NC (US); Matthew J. Davis, Greensboro, NC (US); Jan-Willem Zweers, Nieuwleusen (NL); Bhargava Teja Nukala, High Point, NC (US); John Bellantoni, San Jose, CA (US)

(21) Appl. No.: 19/344,684

(22) Filed: Sep. 30, 2025

Related U.S. Application Data
(60) Provisional application No. 63/704,744, filed on Oct. 8, 2024.
(60) Provisional application No. 63/754,885, filed on Feb. 6, 2025.

(51) Int. Cl. H04L 12/403; H04L 12/40

(52) U.S. Cl. CPC H04L 12/403; H04L 12/40097; H04L 2012/40273

(57) ABSTRACT

A multi-bus wireless communication system is disclosed. The multi-bus wireless communication system includes a network access circuit and a radio access circuit, which are physically separated but interconnected via a coaxial bus(es). The radio access circuit includes an antenna(s) and an electronic device(s) for optimizing the antenna(s) based on a bus telegram(s) communicated over a single-wire bus(es). The network access circuit generates and multiplexes the bus telegram(s) with a radio frequency (RF) signal(s) for communication to the radio access circuit over the coaxial bus(es). The radio access circuit, sequentially, demultiplexes the multiplexed signal(s) into the RF signal(s) and the bus telegram(s). Accordingly, the radio access circuit can control the electronic device(s) to optimize the antenna(s). By multiplexing and demultiplexing the RF signal(s) and the bus telegram(s) on opposite ends of the multi-bus wireless communication system, it is possible to optimize the antenna(s) over the coaxial bus(es) in a vehicular environment.

### RELATED APPLICATIONS

This application claims the benefit of U.S. provisional patent application Ser. No. 63/704,744, filed on Oct. 8, 2024, and U.S. provisional patent application Ser. No. 63/754,885, filed on Feb. 6, 2025, the disclosures of which are hereby incorporated herein by reference in their entireties.

### FIELD OF THE DISCLOSURE

The technology of the disclosure relates generally to a multi-bus wireless communication system, such as a vehicular wireless communication system, configured to operate based on mixed types of communication buses.

### BACKGROUND

Mobile communications have become increasingly common in current society. The prevalence of various mobile communication technologies is driven in part by the many functions that are now enabled on wireless communication devices. Increased processing capabilities in such devices helped evolve wireless communication devices from being pure communication tools into sophisticated mobile multimedia centers that enable enhanced user experiences.

As automobiles are becoming increasingly complex and advanced, mobile communication has become an integral part in state-of-the-art vehicles. Popular and trendy vehicular applications, such as high-definition navigation, real-time communication, on-demand entertainment, advanced driver assistance systems (ADASs), and autonomous driving systems, are all relying on fast and reliable vehicular wireless communication systems (e.g., 4G or 5G systems) to function.

Vehicular wireless communication systems have faced some unique challenges not seen in other wireless communication devices like smartphones. In a vehicular wireless communication system, a vehicular antenna system is typically mounted on an exterior (e.g., rooftop) of a vehicle and exposed to a harsher environment. In contrast, a wireless transceiver is usually installed inside a climate-controlled interior (e.g., dashboard) of the vehicle. Such unique topology requires running a long coaxial cable from the wireless transceiver to the antenna system. As a result, many antenna control and optimization techniques commonly found in handheld communication devices (e.g., smartphones) become infeasible in the vehicular environment due to extended physical separation between the wireless transceiver and the antenna system. As such, there is a need for a simple and low-cost vehicular wireless communication system wherein the transceiver circuit can optimize the antenna system over a coaxial bus(es) based on means commonly utilized in the handheld communication devices.

### SUMMARY

Aspects disclosed in the detailed description are related to a multi-bus wireless communication system. The multi-bus wireless communication system includes a network access circuit and a radio access circuit, which are physically separated but interconnected via a coaxial bus(es). The radio access circuit includes an antenna(s) for transmitting and receiving a radio frequency (RF) signal(s), and an electronic device(s) (e.g., antenna tuner) for optimizing the antenna(s) based on a bus telegram(s) communicated over a single-wire bus(es). Herein, the single-wire bus(es) is provided in both the network access circuit and the radio access circuit but solely controlled by the network access circuit. Specifically, the network access circuit generates and multiplexes the bus telegram(s) with the RF signal(s) for communication to the radio access circuit over the coaxial bus(es). The radio access circuit, in turn, demultiplexes the multiplexed signal(s) into the RF signal(s) and the bus telegram(s). Accordingly, the radio access circuit can communicate the RF signal(s) via the antenna(s) and control the electronic(s) to optimize the antenna(s). By multiplexing and demultiplexing the RF signal(s) and the bus telegram(s) on opposite ends of the multi-bus wireless communication system, it is possible to optimize the antenna(s) over the coaxial bus(es), thus making it possible for the multi-bus wireless communication system to be used in a vehicular environment.

In one aspect, a multi-bus wireless communication system is provided. The multi-bus wireless communication system includes a network access circuit. The network access circuit is coupled to multiple coaxial buses and includes multiple single-wire buses. The network access circuit is configured to receive multiple forward bus telegrams via the multiple single-wire buses. The network access circuit is also configured to multiplex the multiple forward bus telegrams with an RF transmit signal to generate at least one forward communication signal. The network access circuit is also configured to communicate the at least one forward communication signal via one or more of the multiple coaxial buses. The multi-bus wireless communication system also includes a radio access circuit. The radio access circuit is coupled to the multiple coaxial buses and includes the multiple single-wire buses. The radio access circuit is configured to receive the at least one forward communication signal via the one or more of the multiple coaxial buses. The radio access circuit is also configured to demultiplex the at least one forward communication signal into the RF transmit signal and the multiple forward bus telegrams. The frontend interface circuit is also configured to communicate the multiple forward bus telegrams via the multiple single-wire buses.

In another aspect, a vehicular wireless communication system is provided. The vehicular wireless communication system includes a multi-bus wireless communication system. The multi-bus wireless communication system includes a network access circuit. The network access circuit is coupled to multiple coaxial buses and includes multiple single-wire buses. The network access circuit is configured to receive multiple forward bus telegrams via the multiple single-wire buses. The network access circuit is also configured to multiplex the multiple forward bus telegrams with an RF transmit signal to generate at least one forward communication signal. The network access circuit is also configured to communicate the at least one forward communication signal via one or more of the multiple coaxial buses. The multi-bus wireless communication system also includes a radio access circuit. The radio access circuit is coupled to the multiple coaxial buses and includes the multiple single-wire buses. The radio access circuit is configured to receive the at least one forward communication signal via the one or more of the multiple coaxial buses. The radio access circuit is also configured to demultiplex the at least one forward communication signal into the RF transmit signal and the multiple forward bus telegrams. The radio access circuit is also configured to communicate the multiple forward bus telegrams via the multiple single-wire buses.

In another aspect, a method for operating a multi-bus wireless communication system is provided. The method includes receiving multiple forward bus telegrams via multiple single-wire buses. The method also includes multiplexing the multiple forward bus telegrams with an RF transmit signal to generate at least one forward communication signal. The method also includes communicating the at least one forward communication signal via one or more of multiple coaxial buses. The method also includes receiving the at least one forward communication signal via the multiple coaxial buses. The method also includes demultiplexing the at least one forward communication signal into the RF transmit signal and the multiple forward bus telegrams. The method also includes communicating the multiple forward bus telegrams via the multiple single-wire buses.

Those skilled in the art will appreciate the scope of the disclosure and realize additional aspects thereof after reading the following detailed description in association with the accompanying drawings.

### BRIEF DESCRIPTION OF THE DRAWINGS

The accompanying drawings incorporated in and forming a part of this specification illustrate several aspects of the disclosure and, together with the description, serve to explain the principles of the disclosure.

FIG. 1A is a schematic diagram of an exemplary conventional single-wire bus apparatus in which a main circuit is configured to communicate with a subordinate circuit(s) over a single-wire bus;

FIG. 1B is a schematic diagram providing an exemplary illustration of one or more forward bus telegrams communicated from the main circuit to the subordinate circuit(s) over the single-wire bus of FIG. 1A;

FIG. 1C is a schematic diagram providing an exemplary illustration of one or more reverse bus telegrams communicated from the subordinate circuit(s) to the main circuit over the single-wire bus of FIG. 1A;

FIG. 2 is a schematic diagram of an exemplary high-level overview of a multi-bus wireless communication system wherein the conventional single-wire bus apparatus of FIG. 1A can be deployed between a network access circuit and a radio access circuit that are physically separated but interconnected by a coaxial bus(es);

FIG. 3 is a schematic diagram of an exemplary multi-bus wireless communication system configured according to one embodiment of the present disclosure;

FIG. 4 is a schematic diagram of an exemplary multi-bus wireless communication system configured according to another embodiment of the present disclosure;

FIG. 5 is a schematic diagram of an exemplary multi-bus wireless communication system configured according to another embodiment of the present disclosure;

FIG. 6 is a schematic diagram providing an exemplary illustration of an alternative configuration to the multi-bus wireless communication system of FIG. 5;

FIG. 7 is a schematic diagram of a vehicle wherein the multi-bus wireless communication systems of FIGS. 2-6 can be provided;

FIG. 8 is a schematic diagram of an exemplary communication device wherein the multi-bus wireless communication systems of FIGS. 2-6 can be provided; and

FIG. 9 is a flowchart of an exemplary process for operating the multi-bus wireless communication systems of FIGS. 2-6.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Aspects disclosed in the detailed description are related to a multi-bus wireless communication system. The multi-bus wireless communication system includes a network access circuit and a radio access circuit, which are physically separated but interconnected via a coaxial bus(es). The radio access circuit includes an antenna(s) for transmitting and receiving a radio frequency (RF) signal(s), and an electronic device(s) (e.g., antenna tuner) for optimizing the antenna(s) based on a bus telegram(s) communicated over a single-wire bus(es). Herein, the single-wire bus(es) is provided in both the network access circuit and the radio access circuit but solely controlled by the network access circuit. Specifically, the network access circuit generates and multiplexes the bus telegram(s) with the RF signal(s) for communication to the radio access circuit over the coaxial bus(es). The radio access circuit, in turn, demultiplexes the multiplexed signal(s) into the RF signal(s) and the bus telegram(s). Accordingly, the radio access circuit can communicate the RF signal(s) via the antenna(s) and control the electronic device(s) to optimize the antenna(s). By multiplexing and demultiplexing the RF signal(s) and the bus telegram(s) on opposite ends of the multi-bus wireless communication system, it is possible to optimize the antenna(s) over the coaxial bus(es), thus making it possible for the multi-bus wireless communication system to be used in a vehicular environment.

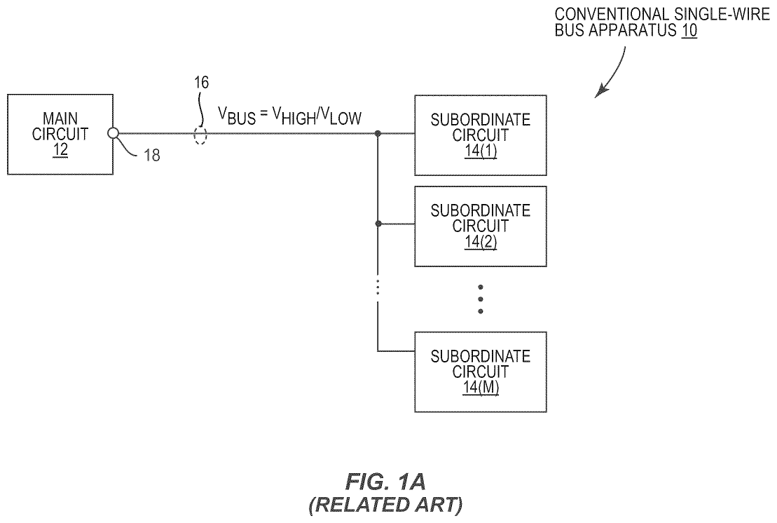

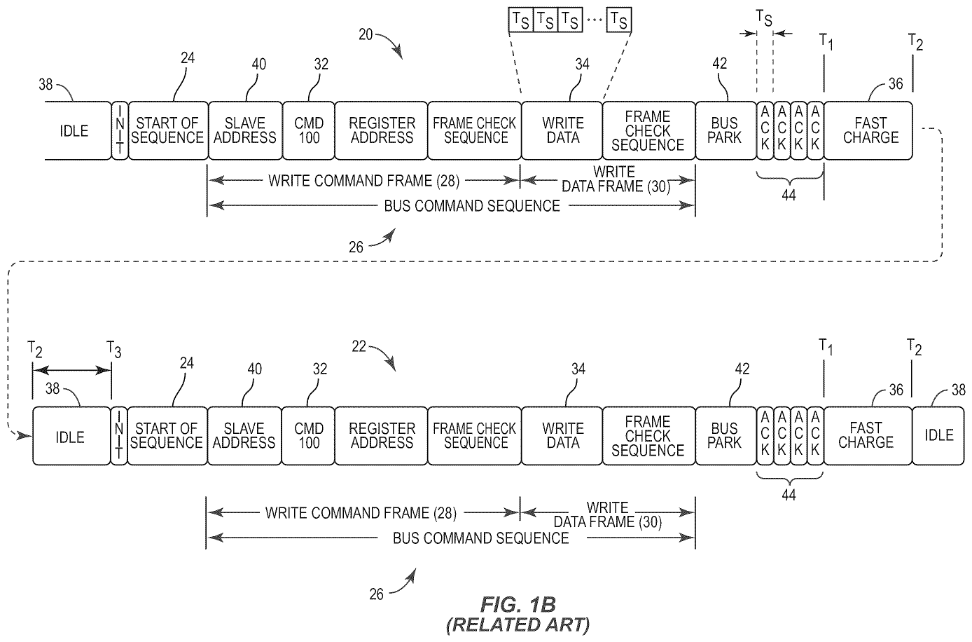

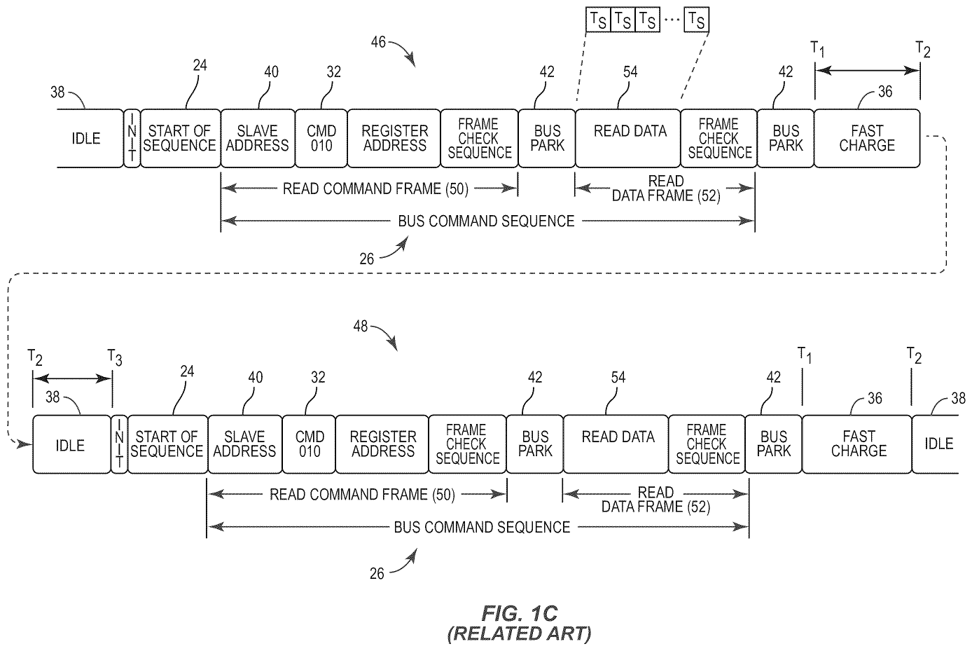

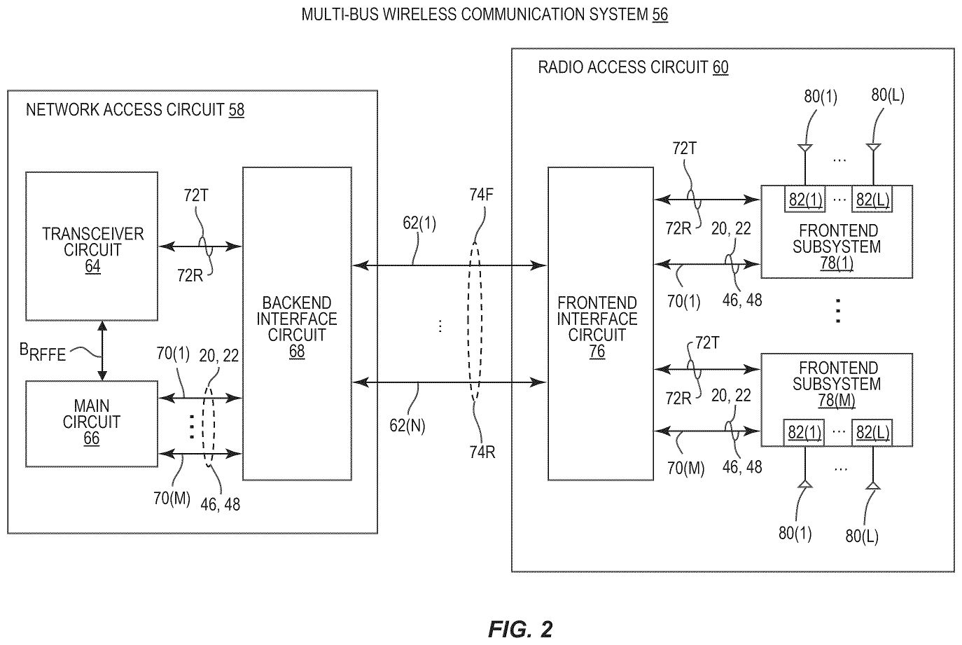

Before discussing a multi-bus wireless communication system that incorporates a coaxial bus(es) and a single-wire bus(es), starting at FIG. 2, a brief overview of a conventional single-wire bus apparatus is first provided with reference to FIGS. 1A-1C to help understand basic operations of the single-wire bus.

In this regard, FIG. 1A is a schematic diagram of an exemplary conventional single-wire bus apparatus 10 in which a main circuit 12 is configured to communicate with a number of subordinate circuits 14(1)-14(M) over a single-wire bus 16 coupled to a main port 18. The main circuit 12 is configured to always initiate a communication over the single-wire bus 16 by communicating a bus telegram(s) to one or more of the subordinate circuits 14(1)-14(M). As such, the conventional single-wire bus apparatus 10 is also known as a “main-subordinate” or “master-slave” bus architecture. The subordinate circuits 14(1)-14(M) may provide a data payload(s) to the main circuit 12 over the single-wire bus 16 in response to receiving the bus telegram(s) from the main circuit 12. Hereinafter, the bus telegram(s) communicated from the main circuit 12 to the subordinate circuits 14(1)-14(M) is referred to as “a forward bus telegram(s)” and the data payload(s) communicated from the subordinate circuits 14(1)-14(M) to the main circuit 12 is referred to as “a reverse bus telegram(s).”

FIG. 1B is a schematic diagram providing an exemplary illustration of one or more forward bus telegrams 20, 22 communicated from the main circuit 12 to any of the subordinate circuits 14(1)-14(M) over the single-wire bus 16 of FIG. 1A. Each of the forward bus telegrams 20, 22 begins with an SOS sequence 24, followed by a bus command sequence 26. The bus command sequence 26 includes a write command frame 28 and a write data frame 30. The write command frame 28 includes a command field 32 (denoted as “CMD”), which is encoded with a binary value “100” to indicate a register-write operation. The write data frame 30 includes a write data period 34. The write data period 34 can include one or more write data symbols Ts modulated to carry data to the subordinate circuits 14(1)-14(M) during the register-write operation. In context of the present disclosure, the write data symbols Ts are also referred to as forward data symbols.

The SOS sequence 24 always precedes the bus command sequence 26 and is always communicated from the main circuit 12 to the subordinate circuits 14(1)-14(M). The forward bus telegram 22, which succeeds the forward bus telegram 20, may be separated from the forward bus telegram 20 by a fast-charge period 36 that starts at time T₁ and ends at time T₂ (T₂>T₁) and an idle period 38 that starts at time T₂ and ends at time T₃ (T₃>T₂). During the idle period 38, both the main circuit 12 and the subordinate circuits 14(1)-14(M) are refrained from communications over the single-wire bus 16. Collectively, a duration between time T₁ and T₃ is also referred to as a suspension period (T₃-T₁).

The bus command sequence includes a subordinate address field 40 (denoted as “slave address”) and is followed by a bus park period 42 and subsequently four acknowledgement (ACK) symbols 44. The subordinate address field 40 can be used to address the subordinate circuits 14(1)-14(M). The bus park period 42 may be used to switch between the forward and the reverse communication modes. The ACK symbols 44 can be used by up to four of the subordinate circuits 14(1)-14(M) to acknowledge a respective receipt of the data carried in the write data period 34. Given that the ACK symbols 44 are each associated with a symbol duration Ts and communicated immediately before the fast-charge period 36, each of the subordinate circuits 14(1)-14(M) can determine the time T₁ to start the fast-charge period 36 by counting four ACKs communicated in the four ACK symbols 44 from the end of the bus park period 42. In context of the present disclosure, the ACK symbols 44 are one type of reverse data symbols.

Each of the subordinate circuits 14(1)-14(M) is uniquely identified by a respective unique subordinate identification (USID). As such, the bus command sequence 26 in the forward bus telegrams 20, 22 can be a unicast command sequence destined to any one of the subordinate circuits 14(1)-14(M) when the subordinate address field 40 contains the USID of any one of the subordinate circuits 14(1)-14(M). The bus command sequence 26 in the forward bus telegrams 20, 22 can also be a multicast command sequence destined to a subset of the subordinate circuits 14(1)-14(M) when the subordinate address field 40 contains a group subordinate identification (GSID) corresponding to the subset of the subordinate circuits 14(1)-14(M). Furthermore, the bus command sequence 26 in the forward bus telegrams 20, 22 can be a broadcast command sequence destined to all of the subordinate circuits 14(1)-14(M) when the subordinate address field 40 contains a broadcast subordinate identification (BSID).

FIG. 1C is a schematic diagram providing an exemplary illustration of one or more reverse bus telegrams 46, 48 communicated from the subordinate circuits 14(1)-14(M) to the main circuit 12 over the single-wire bus 16 of FIG. 1A. Common elements between FIGS. 1B and 1C are shown therein with common element numbers and will not be re-described herein.

Each of the reverse bus telegrams 46, 48 includes the bus command sequence 26. The bus command sequence 26 includes a read command frame 50 and a read data frame 52, separated by a bus park period 42. The read command frame 50 includes the command field 32 (denoted as “CMD”), which is encoded with a binary value “010” to indicate a register-read operation. The read data frame 52 includes a read data period 54, which includes one or more read data symbols Ts modulated to carry data payloads to the main circuit 12 during the register-read operation. The main circuit 12 first communicates the read command frame 50 to the subordinate circuits 14(1)-14(M) identified by the subordinate address field 40 to initiate the register-read operation. The main circuit 12 then tri-states during the bus park period 42 to yield control of the single-wire bus 16 to the subordinate circuits 14(1)-14(M). Subsequently, the subordinate circuits 14(1)-14(M) can begin sending the data payloads in one or more read data symbols Ts in the read data period 54. In context of the present disclosure, the read data symbols Ts are another type of reverse data symbols.

With reference back to FIG. 1A, the main circuit 12 is configured to suspend the bus telegram communication over the single-wire bus 16 during the suspension period (T₃−T₁). Accordingly, the main circuit 12 and the subordinate circuits 14(1)-14(M) are configured to refrain from communicating the bus telegram(s) and data payload(s) from time T₁ to time T₃. During the suspension period (T₃−T₁), the main circuit 12 maintains the single-wire bus 16 at a bus voltage V_{BUS} at a high voltage level V_{HIGH} (V_{HIGH}>0 V). As such, the subordinate circuits 14(1)-14(M) can each draw a charging current over the single-wire bus 16 to thereby harvest power from the main circuit 12. Outside the suspension period (T₃−T₁), the write data symbols Ts in the write data period 34 and the read data symbols Ts in the read data period 54 can be pulse-width modulated by toggling the bus voltage V_{BUS} between the high voltage level V_{HIGH} and a low voltage level V_{LOW} (V_{LOW}<V_{HIGH}).

The conventional single-wire bus apparatus 10 has long been used as a simple and low-cost tool to perform antenna tuning in mobile communication devices (e.g., smartphones). As an example, the main circuit 12 can be a transceiver and each of the subordinate circuits 14(1)-14(M) can be an antenna tuner. The transceiver can provide antenna tuning instructions via the forward bus telegrams 20, 22, and the antenna tuners can perform antenna tuning accordingly and provide status reports in the reverse bus telegrams 46, 48. Understandably, the transceiver and the antenna tuners are typically collocated in the mobile communication device, whereas in a vehicular system the transceiver and the antenna system are physically separated and interconnected by a coaxial bus(es). As such, it is desirable to incorporate the conventional single-wire bus apparatus 10 into a vehicular wireless communication system to help optimize (e.g., tuning) performance of the antenna system.

In this regard, FIG. 2 is a schematic diagram of an exemplary high-level overview of a multi-bus wireless communication system 56 wherein the single-wire bus 16 in the conventional single-wire bus apparatus 10 of FIG. 1A can be deployed between a network access circuit 58 and a radio access circuit 60 that are physically separated but interconnected by multiple coaxial buses 62(1)-62(N). Herein, the network access circuit 58 includes a transceiver circuit 64, a main circuit 66, and a backend interface circuit 68. The main circuit 66, which is functionally equivalent to the main circuit 12 in the conventional single-wire bus apparatus 10, is coupled to the transceiver circuit 64 via a radio frequency frontend (RFFE) bus B_{RFFE} and to the backend interface circuit 68 via one or more single-wire buses 70(1)-70(M), each of which is identical to the single-wire bus 16 in FIG. 1A. Like the main circuit 12, the main circuit 66 is configured to communicate the forward bus telegrams 20, 22 to the backend interface circuit 68 and receive the reverse bus telegrams 46, 48 from the backend interface circuit 68 via the single-wire buses 70(1)-70(M).

The transceiver circuit 64 is configured to transmit an RF transmit signal 72T and receive an RF receive signal 72R via the backend interface circuit 68. The backend interface circuit 68 is configured to multiplex each of the forward bus telegrams 20, 22 with the RF transmit signal 72T to thereby generate at least one forward communication signal 74F and provide the forward communication signal 74F to the radio access circuit 60 via one or more of the coaxial buses 62(1)-62(N).

The radio access circuit 60 includes a frontend interface circuit 76 and one or more frontend subsystems 78(1)-78(M). The frontend interface circuit 76 is coupled to the backend interface circuit 68 via the coaxial buses 62(1)-62(N). The frontend interface circuit 76 receives the forward communication signal 74F via the coaxial buses 62(1)-62(N) and demultiplexes the forward communication signal 74F into the RF transmit signal 72T and the forward bus telegrams 20, 22.

In an embodiment, each of the frontend subsystems 78(1)-78(M) can include or be coupled to one or more antennas 80(1)-80(L) for transmitting the RF transmit signal 72T and receiving the RF receive signal 72R. In various embodiments, a number of the antennas 80(1)-80(L) can be more than a number of the frontend subsystems 78(1)-78(M) (L>M), equal to the number of the frontend subsystems 78(1)-78(M) (L=M), or less than the number of the frontend subsystems 78(1)-78(M) (L<M). In this regard, depending on specific applications, the RF transmit signal 72T may be transmitted via any one or more of the antennas 80(1)-80(L) in any one or more of the frontend subsystems 78(1)-78(M). Likewise, the RF receive signal 72R may be received via any one or more of the antennas 80(1)-80(L) in any one or more of the frontend subsystems 78(1)-78(M).

Each of the frontend subsystems 78(1)-78(M) also includes one or more embedded electronics 82(1)-82(L) (e.g., antenna tuners) for optimizing the antennas 80(1)-80(L), respectively. Herein, the embedded electronics 82(1)-82(L) are functionally equivalent to the subordinate circuits 14(1)-14(M) in the conventional single-wire bus apparatus 10. In this regard, each of the embedded electronics 82(1)-82(L) in a respective one of the frontend subsystems 78(1)-78(M) is coupled to the frontend interface circuit 76 via a respective one of the single-wire buses 70(1)-70(M). As an example, each of the embedded electronics 82(1)-82(L) in the frontend subsystem 78(1) is coupled to the frontend interface circuit 76 via the single-wire bus 70(1), whereas each of the embedded electronics 82(1)-82(L) in the frontend subsystem 78(M) is coupled to the frontend interface circuit 76 via the single-wire bus 70(M). Accordingly, each of the embedded electronics 82(1)-82(L) in each of the frontend subsystems 78(1)-78(M) can receive the forward bus telegrams 20, 22 from the frontend interface circuit 76 via the respective one of the single-wire buses 70(1)-70(M).

Like the subordinate circuits 14(1)-14(M), each of the embedded electronics 82(1)-82(L) in each of the frontend subsystems 78(1)-78(M) can also communicate the reverse bus telegrams 46, 48 to the frontend interface circuit 76 via the respective one of the single-wire buses 70(1)-70(M). The frontend interface circuit 76 can be configured to multiplex the RF receive signal 72R with the reverse bus telegrams 46, 48 received from the embedded electronics 82(1)-82(L) in each of the frontend subsystems 78(1)-78(M) to thereby generate a reverse communication signal 74R and provide the reverse communication signal 74R to the backend interface circuit 68 via one or more of the coaxial buses 62(1)-62(N).

The backend interface circuit 68 is configured to demultiplex the reverse communication signal 74R into the RF receive signal 72R and the reverse bus telegrams 46, 48. Subsequently, the backend interface circuit 68 can provide the RF receive signal 72R to the transceiver circuit 64, and provide the reverse bus telegrams 46, 48 to the main circuit 66 via one or more of the single-wire buses 70(1)-70(M). As an example, the reverse bus telegrams 46, 48 received from the frontend subsystem 78(1) are provided to the main circuit 66 via the single-wire bus 70(1), whereas the reverse bus telegrams 46, 48 received from the frontend subsystem 78(M) are provided to the main circuit 66 via the single-wire bus 70(M). In this regard, the backend interface circuit 68, the coaxial buses 62(1)-62(N), and the frontend interface circuit 76 collectively form a bridge between the main circuit 66 and the embedded electronics 82(1)-82(L), thus allowing the single-wire buses 70(1)-70M) to each operate like the single-wire bus 16 in the conventional single-wire bus apparatus 10. As a result, it is possible to optimize the antennas 80(1)-80(L) in each of the frontend subsystems 78(1)-78(M) over the coaxial buses 62(1)-62(N), thus making it possible to enable antenna optimization in a vehicular environment based on topology and operation of the conventional single-wire bus apparatus 10.

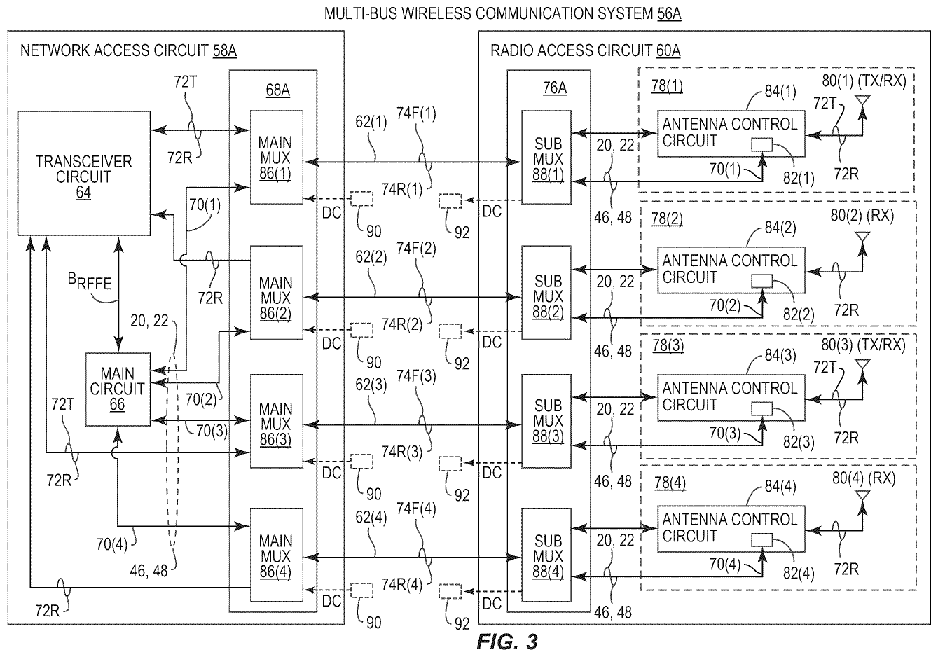

The multi-bus wireless communication system 56 can be configured according to various embodiments of the present disclosure, as described in FIGS. 3-6. Common elements between FIGS. 2-6 are shown therein with common element numbers and will not be re-described herein.

For the sake of simplicity, the multi-bus wireless communication system is described in FIGS. 3-6 based on a 4-antenna configuration. As such, the multi-bus wireless communication system can be configured to support a 2-transmit and 4-receive (2×4) multiple-input multiple-output (MIMO) operation. However, the illustrations in FIGS. 3-6 shall not be considered as limiting. As an example, the multi-bus wireless communication system described herein can also be adapted to include fewer or more antennas to thereby support 2×2, 4×4, 4×8, and 8×8 MIMO operations.

FIG. 3 is a schematic diagram of an exemplary multi-bus wireless communication system 56A configured according to one embodiment of the present disclosure. Herein, the multi-bus wireless communication system 56A includes a network access circuit 58A and a radio access circuit 60A that are physically separated but interconnected by four coaxial buses 62(1)-62(4) among the coaxial buses 62(1)-62(N) in FIG. 2. The network access circuit 58A includes a backend interface circuit 68A and the radio access circuit 60A includes a frontend interface circuit 76A. The backend interface circuit 68A and the frontend interface circuit 76A are interconnected via the coaxial buses 62(1)-62(4).

The backend interface circuit 68A is coupled to the main circuit 66 via four single-wire buses 70(1)-70(4) among the single-wire buses 70(1)-70(M) in FIG. 2. Like the main circuit 66 in FIG. 2, the main circuit 66 in the network access circuit 58A can transmit the forward bus telegrams 20, 22 and receive the reverse bus telegrams 46, 48 via each of the single-wire buses 70(1)-70(4).

The radio access circuit 60A includes four frontend subsystems 78(1)-78(4) among the frontend subsystems 78(1)-78(M) in FIG. 2, each of which includes a respective one of four antenna control circuits 84(1)-84(4) coupled to a respective one of four antennas 80(1)-80(4). Herein, each of the antenna control circuits 84(1)-84(4) further includes a respective one of four embedded electronics 82(1)-82(4) among the embedded electronics 82(1)-82(L) in FIG. 2 (e.g., antenna tuners) that can be configured to optimize a respective one of the antennas 80(1)-80(4) among the antennas 80(1)-80(L) in FIG. 2. Each of the embedded electronics 82(1)-82(4) is also coupled to the frontend interface circuit 76A via a respective one of the single-wire buses 70(1)-70(4) and functions as a subordinate to the main circuit 66 in the network access circuit 58A. In this regard, each of the embedded electronics 82(1)-82(4) can also receive the forward bus telegrams 20, 22 and communicate the reverse bus telegrams 46, 48 via the respective one of the single-wire buses 70(1)-70(4). In addition, as previously discussed in FIG. 1A, each of the embedded electronics 82(1)-82(4) can draw power from the main circuit 66 via the respective one of the single-wire buses 70(1)-70(4) during the suspension period (T₃−T₁).

In an embodiment, the antennas 80(1) and 80(3) are both transmit/receive (TX/RX) antennas, whereas the antennas 80(2) and 80(4) are diversity receive (RX) antennas. As such, the radio access circuit 60A can simultaneously transmit the RF transmit signal 72T via the antennas 80(1) and 80(3) and simultaneously receive the RF receive signal 72R via the antennas 80(1)-80(4) in the 2×4 MIMO operation.

The backend interface circuit 68A includes four main multiplexer circuits 86(1)-86(4) and the frontend interface circuit 76A includes four subordinate multiplexer circuits 88(1)-88(4). The main multiplexer circuits 86(1)-86(4) are coupled to the subordinate multiplexer circuits 88(1)-88(4) via the coaxial buses 62(1)-62(4), respectively. Herein, the main multiplexer circuits 86(1)-86(4) and the subordinate multiplexer circuits 88(1)-88(4) have equal capabilities in multiplexing and demultiplexing signals. However, given that the multi-bus wireless communication system 56A is configured to support the 2×4 MIMO operation, the main multiplexer circuits 86(1)-86(4) are divided into two subsets, namely a first subset of main multiplexer circuits including the main multiplexer circuits 86(1) and 86(3) and a second subset of main multiplexer circuits including the main multiplexer circuits 86(2) and 86(4). Similarly, the subordinate multiplexer circuits 88(1)-88(4) are divided into two subsets, namely a first subset of subordinate multiplexer circuits including the subordinate multiplexer circuits 88(1) and 88(3) and a second subset of subordinate multiplexer circuits including the subordinate multiplexer circuits 88(2) and 88(4).

The backend interface circuit 68A is configured to generate four forward communication signals 74F(1)-74F(4) and communicate the forward communication signals 74F(1)-74F(4) to the frontend interface circuit 76A via the coaxial buses 62(1)-62(4), respectively. More specifically, each of the first subset of main multiplexer circuits 86(1) and 86(3) is configured to multiplex the RF transmit signal 72T with the forward bus telegrams 20, 22 to thereby generate a respective one of the forward communication signals 74F(1) and 74F(3). In contrast, each of the second subset of main multiplexer circuits 86(2) and 86(4) is configured to generate a respective one of the forward communication signals 74F(2) and 74F(4) that includes only the forward bus telegrams 20, 22 without the RF transmit signal 72T. Accordingly, only the first subset of main multiplexer circuits 86(1) and 86(3) will each receive the RF transmit signal 72T from the transceiver circuit 64.

The first subset of subordinate multiplexer circuits 88(1) and 88(3) are configured to receive the forward communication signals 74F(1) and 74F(3) via the coaxial buses 62(1) and 62(3), respectively. Accordingly, each of the first subset of subordinate multiplexer circuits 88(1) and 88(3) is configured to demultiplex a respective one of the forward communication signals 74F(1) and 74F(3) into the RF transmit signal 72T and the forward bus telegrams 20, 22. The first subset of subordinate multiplexer circuits 88(1) and 88(3) then provide the RF transmit signal 72T to the antenna control circuits 84(1) and 84(3) for concurrent transmission via the antennas 80(1) and 80(3), respectively.

The second subset of subordinate multiplexer circuits 88(2) and 88(4) are configured to receive the forward communication signals 74F(2) and 74F(4) via the coaxial buses 62(2) and 62(4), respectively. Accordingly, each of the second subset of subordinate multiplexer circuits 88(2) and 88(4) is configured to demultiplex a respective one of the forward communication signals 74F(2) and 74F(4) into the forward bus telegrams 20, 22. Each of the subordinate multiplexer circuits 88(1)-88(4) can then provide the forward bus telegrams 20, 22 to a respective one of the embedded electronics 82(1)-82(4) via a respective one of the single-wire buses 70(1)-70(4).

Since all of the antennas 80(1)-80(4) are configured to simultaneously receive the RF receive signal 72R, each of the subordinate multiplexer circuits 88(1)-88(4) is configured to receive the RF receive signal 72R from a respective one of the antenna control circuits 84(1)-84(4). Each of the subordinate multiplexer circuits 88(1)-88(4) will then multiplex the RF receive signal 72R with the reverse bus telegrams 46, 48 received from a respective one of the embedded electronics 82(1)-82(4) to thereby generate a respective one of four reverse communication signals 74R(1)-74R(4). Accordingly, the subordinate multiplexer circuits 88(1)-88(4) can provide the reverse communication signals 74R(1)-74R(4) to the backend interface circuit 68A via the coaxial buses 62(1)-62(4), respectively.

Each of the main multiplexer circuits 86(1)-86(4) is configured to demultiplex a respective one of the reverse communication signals 74R(1)-74R(4) into the RF receive signal 72R and the reverse bus telegrams 46, 48. Accordingly, each of the main multiplexer circuits 86(1)-86(4) provides the RF receive signal 72R to the transceiver circuit 64. Each of the main multiplexer circuits 86(1)-86(4) also provides the reverse bus telegrams 46, 48 to the main circuit 66 via the single-wire buses 70(1)-70(4), respectively.

Although each of the embedded electronics 82(1)-82(4) can draw power from the main circuit 66 during the suspension period (T₃−T₁), it may be necessary to provide additional power from the network access circuit 58A to the radio access circuit 60A in some operating scenarios. In this regard, the multi-bus wireless communication system 56A may be optionally configured to provide additional power from the network access circuit 58A to the radio access circuit 60A. In an embodiment, it is also possible to multiplex direct-current (DC) power into the forward communication signals 74F(1)-74F(4). In this regard, each of the main multiplexer circuits 86(1)-86(4) can be coupled to a main bias-T 90 to thereby add the DC power onto the forward communication signals 74F(1)-74F(4). Similarly, each of the subordinate multiplexer circuits 88(1)-88(4) can be coupled to a subordinate bias-T network 92 to thereby receive the DC power from the forward communication signals 74F(1)-74F(4). It should be appreciated that the multi-bus wireless communication system 56A can function normally independent of whether the DC power is provided via the coaxial buses 62(1)-62(N).

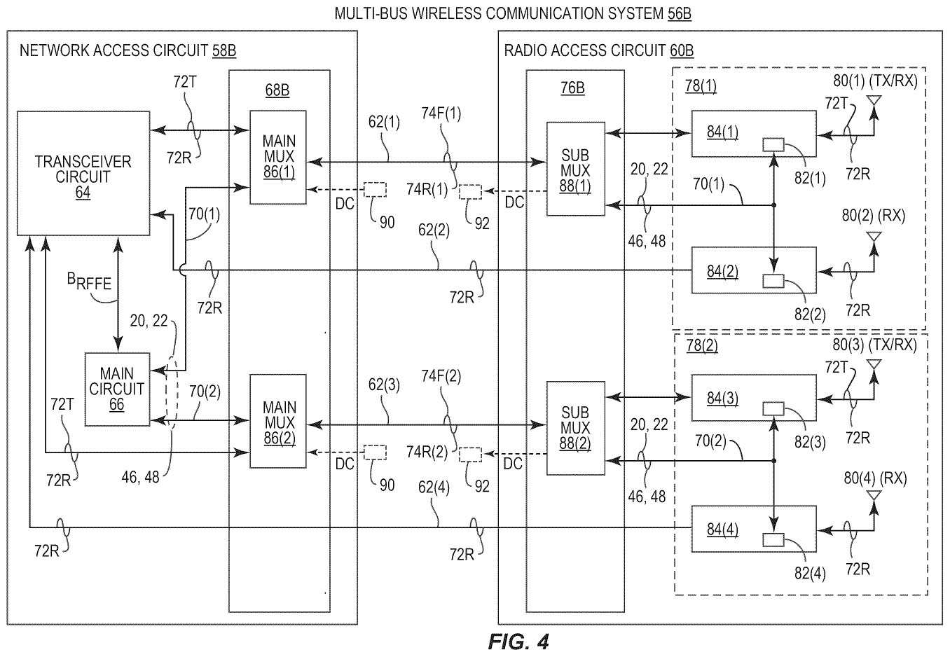

In some embodiments, some of the antennas 80(1)-80(4) can be collocated. In this regard, FIG. 4 is a schematic diagram of an exemplary multi-bus wireless communication system 56B configured according to another embodiment of the present disclosure. The multi-bus wireless communication system 56B includes a network access circuit 58B and a radio access circuit 60B, which are physically separated but interconnected via the coaxial buses 62(1)-62(4). The network access circuit 58B includes a backend interface circuit 68B and the radio access circuit 60B includes a frontend interface circuit 76B.

Herein, the antennas 80(1) and 80(2) are collocated in a frontend subsystem 78(1), and the antennas 80(3) and 80(4) are collocated in another frontend subsystem 78(2). As such, the embedded electronics 82(1) and 82(2) in the frontend subsystem 78(1) can be configured to share a single-wire bus 70(1), and the embedded electronics 82(3) and 82(4) in the frontend subsystem 78(2) can be configured to share another single-wire bus 70(2). As a result, the multi-bus wireless communication system 56B can operate with fewer single-wire buses than the multi-bus wireless communication system 56A of FIG. 3, thus helping to reduce cost and/or footprint of the multi-bus wireless communication system 56B.

In this regard, the backend interface circuit 68B can include a pair of main multiplexer circuits 86(1) and 86(2), each of which is coupled to the main circuit 66 via a respective one of the single-wire buses 70(1) and 70(2). The main multiplexer circuits 86(1) and 86(2) are each configured to receive the RF transmit signal 72T from the transceiver circuit 64 and multiplex the RF transmit signal 72T with the forward bus telegrams 20, 22 received from the main circuit 66 to thereby generate a respective one of a pair of forward communication signals 74F(1) and 74F(2) for communication to the frontend interface circuit 76B via a respective one of the coaxial buses 62(1) and 62(3).

The frontend interface circuit 76B includes a pair of subordinate multiplexer circuits 88(1) and 88(2). Each of the subordinate multiplexer circuits 88(1) and 88(2) receives a respective one of the forward communication signals 74F(1) and 74F(2) via a respective one of the coaxial buses 62(1) and 62(3). Accordingly, each of the subordinate multiplexer circuits 88(1) and 88(2) can demultiplex the respective one of the forward communication signals 74F(1) and 74F(2) into the RF transmit signal 72T and the forward bus telegrams 20, 22. Subsequently, the subordinate multiplexer circuit 88(1) provides the forward bus telegrams 20, 22 to the embedded electronics 82(1) and 82(2) via the single-wire bus 70(1), and the subordinate multiplexer circuit 88(2) provides the forward bus telegrams 20, 22 to the embedded electronics 82(3) and 82(4) via the single-wire bus 70(2). The subordinate multiplexer circuits 88(1) and 88(2) will also provide the RF transmit signal 72T to the antenna control circuits 84(1) and 84(3) for concurrent transmission via the antennas 80(1) and 80(3), respectively.

The antenna control circuits 84(1)-84(4) are configured to receive the RF receive signal 72R via the antennas 80(1)-80(4), respectively. The subordinate multiplexer circuit 88(1) receives the reverse bus telegrams 46, 48 from the embedded electronics 82(1) and 82(2) via the single-wire bus 70(1). The subordinate multiplexer circuit 88(1) also receives the RF receive signal 72R from the antenna control circuit 84(1). Similarly, the subordinate multiplexer circuit 88(2) receives the reverse bus telegrams 46, 48 from the embedded electronics 82(3) and 82(4) via the single-wire bus 70(2). The subordinate multiplexer circuit 88(2) also receives the RF receive signal 72R from the antenna control circuit 84(3). Herein, each of the subordinate multiplexer circuits 88(1) and 88(2) is configured to multiplex the RF receive signal 72R, as received from the antenna control circuits 84(1) and 84(3), with the reverse bus telegrams 46, 48 to thereby generate a respective one of a pair of reverse communication signals 74R(1) and 74R(2). Subsequently, the subordinate multiplexer circuits 88(1) and 88(2) communicate the reverse communication signals 74R(1) and 74R(2) to the backend interface circuit 68B via the coaxial buses 62(1) and 62(3), respectively. In the meantime, the RF receive signal 72R received from the antennas 80(2) and 80(4) are provided directly from the antenna control circuit 84(2) and 84(4) to the transceiver circuit 64 via the coaxial buses 62(2) and 62(4), respectively.

The main multiplexer circuits 86(1) and 86(2) receive the reverse communication signals 74R(1) and 74R(2) via the coaxial buses 62(1) and 62(3), respectively. Each of the main multiplexer circuits 86(1) and 86(2) is configured to demultiplex a respective one of the reverse communication signals 74R(1) and 74R(2) into the RF receive signal 72R and the reverse bus telegrams 46, 48. Each of the main multiplexer circuits 86(1) and 86(2) will provide the RF receive signal 72R to the transceiver circuit 64, and provide the reverse bus telegrams 46, 48 to the main circuit 66 via a respective one of the single-wire buses 70(1) and 70(2).

Although each of the embedded electronics 82(1)-82(4) can draw power from the main circuit 66 during the suspension period (T₃−T₁), it may be necessary to provide additional power from the network access circuit 58B to the radio access circuit 60B in some operating scenarios. In this regard, the multi-bus wireless communication system 56B may be optionally configured to provide additional power from the network access circuit 58B to the radio access circuit 60B. In an embodiment, it is also possible to multiplex DC power into the forward communication signals 74F(1)-74F(2). In this regard, each of the main multiplexer circuits 86(1)-86(2) can be coupled to the main bias-T network 90 to thereby add the DC power onto the forward communication signals 74F(1)-74F(2). Similarly, each of the subordinate multiplexer circuits 88(1)-88(2) can be coupled to the subordinate bias-T network 92 to thereby receive the DC power from the forward communication signals 74F(1)-74F(2). It should be appreciated that the multi-bus wireless communication system 56B can function normally independent of whether the additional DC power is provided via the coaxial buses 62(1) and 62(3).

As discussed earlier, each of the embedded electronics 82(1)-82(4) is configured to draw power from the main circuit 66 during the suspension period (T₃−T₁). Although the energy harvested during the suspension period (T₃−T₁) may be sufficient to power the embedded electronics 82(1)-82(4), the energy harvested during the suspension period (T₃−T₁) may be insufficient to support such active circuits as power amplifiers and low-noise amplifiers. As such, it may be desirable to use a DC power source to provide the additional power needed by the active circuits.

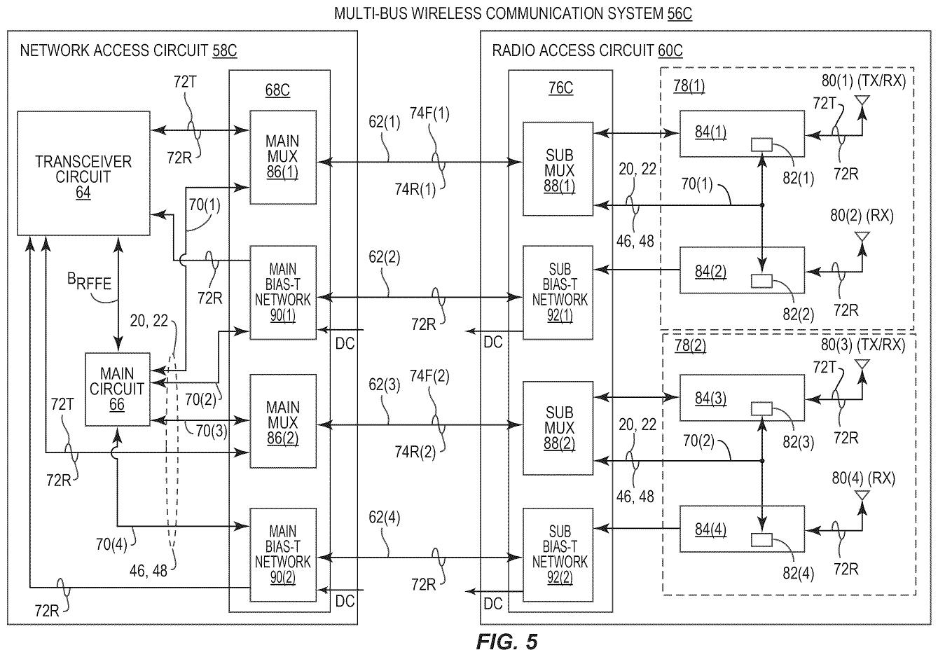

In this regard, FIG. 5 is a schematic diagram of an exemplary multi-bus wireless communication system 56C configured according to another embodiment of the present disclosure to supply additional DC power. The multi-bus wireless communication system 56C includes a network access circuit 58C and a radio access circuit 60C, which are physically separated but interconnected via the coaxial buses 62(1)-62(4). The network access circuit 58C includes a backend interface circuit 68C and the radio access circuit 60C includes a frontend interface circuit 76C.

The backend interface circuit 68C further includes one or more main bias-T networks 90(1) and 90(2), and the frontend interface circuit 76C further includes one or more subordinate bias-T networks 92(1) and 92(2). Herein, a bias-T network refers generally to a circuit that combines a standard bias-T with both a low-pass filter and a high-pass filter. As such, the bias-T network can simultaneously provide a DC power in addition to isolating and passing through an RF signal in a specific frequency range(s). Specifically, the bias-T in the main bias-T networks 90(1) and 90(2) can effectively provide the DC power to the subordinate bias-T networks 92(1) and 92(2) via the coaxial buses 62(2) and 62(4), respectively. Understandably, there can be many different implementations of the main bias-T networks 90(1) and 90(2), which will not be redescribed herein for the sake of brevity.

In an embodiment, the subordinate bias-T networks 92(1) and 92(2) are each configured to receive the DC power from the main bias-T networks 90(1) and 90(2), respectively. In addition, each of the subordinate bias-T networks 92(1) and 92(2) is also configured to pass the RF receive signal 72R, as received from the antennas 80(2) and 80(4), to the main bias-T networks 90(1) and 90(2) via the coaxial buses 62(2) and 62(4), respectively.

Herein, the main multiplexer circuits 86(1)-86(2) in the backend interface circuit 68C are configured to operate like the main multiplexer circuits 86(1)-86(2) in the backend interface circuit 68B in FIG. 4 and the subordinate multiplexer circuits 88(1)-88(2) in the frontend interface circuit 76C are configured to operate like the subordinate multiplexer circuits 88(1)-88(2) in the frontend interface circuit 76B in FIG. 4. The main bias-T networks 90(1) and 90(2), on the other hand, are each configured to receive the RF receive signal 72R via a respective one of the coaxial buses 62(2) and 62(4) and pass the RF receive signal 72R to the transceiver circuit 64.

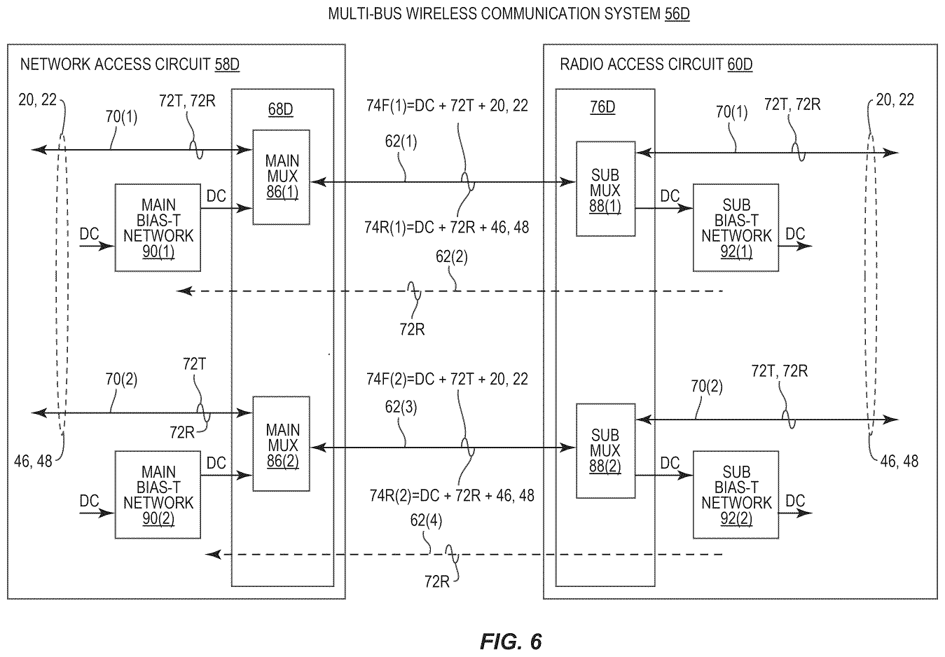

In an alternative embodiment, the main bias-T networks 90(1) and 90(2) can be provided outside the backend interface circuit 68C and the subordinate bias-T networks 92(1) and 92(2) can be provided outside the frontend interface circuit 76C. In this regard, FIG. 6 is a schematic diagram providing an exemplary illustration of an exemplary multi-bus wireless communication system 56D configured according to such an alternative embodiment. Common elements between FIGS. 5 and 6 are shown therein with common element numbers and will not be re-described herein.

Herein, the multi-bus wireless communication system 56D includes a network access circuit 58D and a radio access circuit 60D, wherein a backend interface circuit 68D and a frontend interface circuit 76D replace the backend interface circuit 68C and the frontend interface circuit 76C in FIG. 5, respectively. Like in the network access circuit 58C in FIG. 5, the main multiplexer circuits 86(1), 86(2) are coupled to the transceiver circuit 64 and the main circuit 66, which are omitted herein for simplicity. The main multiplexer circuits 86(1), 86(2) are coupled respectively to the main bias-T networks 90(1), 90(2) to thereby receive the DC power. Accordingly, the main multiplexer circuits 86(1), 86(2) can add the DC power onto the forward communication signals 74F(1), 74F(2), respectively. Similarly, like in the radio access circuit 60C in FIG. 5, the subordinate multiplexer circuits 88(1), 88(2) are coupled to the frontend subsystems 78(1)-78(2), which are omitted herein for simplicity. The subordinate multiplexer circuits 88(1), 88(2) are coupled respectively to the subordinate bias-T networks 92(1), 92(2) to thereby receive the DC power from the forward communication signals 74F(1), 74F(2).

In one embodiment, the coaxial buses 62(2) and 62(4) may be eliminated. Alternatively, the coaxial buses 62(2) and 62(4) may provide a direct path to communicate the RF receive signal 72R, as received via the antennas 80(2) and 80(4), directly from the frontend interface circuit 76D to the backend interface circuit 68D.

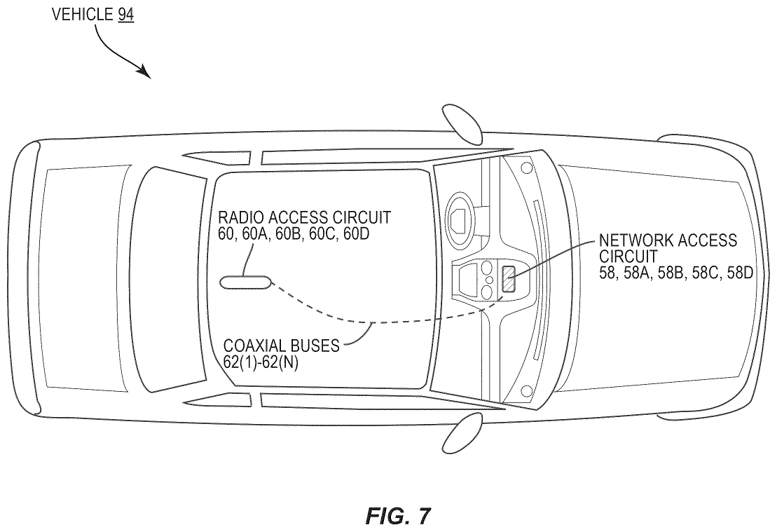

The multi-bus wireless communication system 56 of FIG. 2, the multi-bus wireless communication system 56A of FIG. 3, the multi-bus wireless communication system 56B of FIG. 4, the multi-bus wireless communication system 56C of FIG. 5, and the multi-bus wireless communication system 56D of FIG. 6 can each be provided in a vehicle to support vehicular wireless communications. In this regard, FIG. 7 is a schematic diagram of a vehicle 94 wherein the multi-bus wireless communication system 56 of FIG. 2, the multi-bus wireless communication system 56A of FIG. 3, the multi-bus wireless communication system 56B of FIG. 4, the multi-bus wireless communication system 56C of FIG. 5, and the multi-bus wireless communication system 56D of FIG. 6 can be provided. Common elements between FIGS. 1-7 are shown therein with common element numbers and will not be re-described herein.

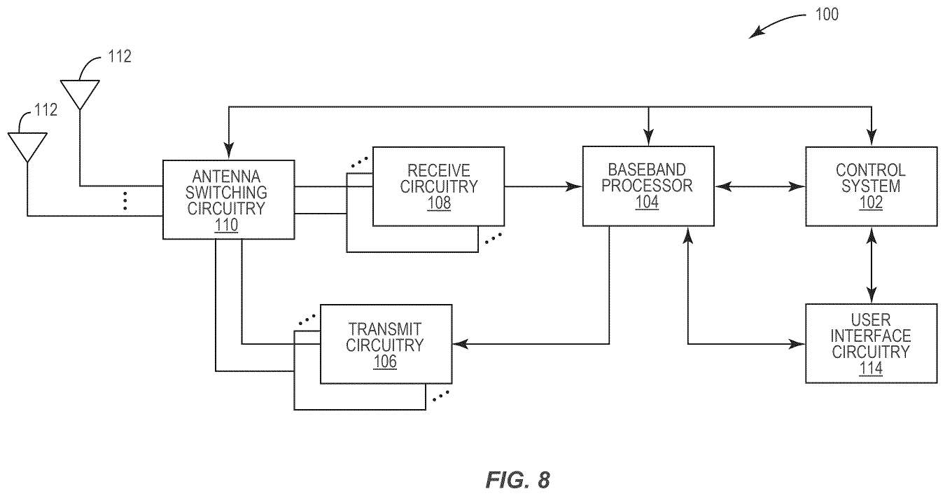

The multi-bus wireless communication system 56 of FIG. 2, the multi-bus wireless communication system 56A of FIG. 3, the multi-bus wireless communication system 56B of FIG. 4, the multi-bus wireless communication system 56C of FIG. 5, and the multi-bus wireless communication system 56D of FIG. 6 can also be provided in a communication device to support the embodiments described above. In this regard, FIG. 8 is a schematic diagram of an exemplary communication device 100 wherein the multi-bus wireless communication system 56 of FIG. 2, the multi-bus wireless communication system 56A of FIG. 3, the multi-bus wireless communication system 56B of FIG. 4, the multi-bus wireless communication system 56C of FIG. 5, and the multi-bus wireless communication system 56D of FIG. 6 can be provided.

Herein, the communication device 100 can be any type of communication devices, such as mobile terminals, smart watches, tablets, computers, navigation devices, access points, base stations (e.g., eNB, gNB, etc.), and like wireless communication devices that support wireless communications, such as cellular, wireless local area network (WLAN), Ultra-wideband (UWB), Bluetooth, and near-field communications. The communication device 100 will generally include a control system 102, a baseband processor 104, transmit circuitry 106, receive circuitry 108, antenna switching circuitry 110, multiple antennas 112, and user interface circuitry 114. In a non-limiting example, the control system 102 can be a field-programmable gate array (FPGA), as an example. In this regard, the control system 102 can include at least a microprocessor, an embedded memory circuit, and a communication bus interface. The receive circuitry 108 receives radio frequency signals via the antennas 112 and through the antenna switching circuitry 110 from one or more base stations. A low-noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams using analog-to-digital converters (ADCs).

The baseband processor 104 processes the digitized received signal to extract the information or data bits conveyed in the received signal. This processing typically comprises demodulation, decoding, and error correction operations, as will be discussed in greater detail below. The baseband processor 104 is generally implemented in one or more digital signal processors (DSPs) and application-specific integrated circuits (ASICs).

For transmission, the baseband processor 104 receives digitized data, which may represent voice, data, or control information, from the control system 102, which it encodes for transmission. The encoded data is output to the transmit circuitry 106, where a digital-to-analog converter (DAC) converts the digitally encoded data into an analog signal and a modulator modulates the analog signal onto a carrier signal that is at a desired transmit frequency or frequencies. A power amplifier will amplify the modulated carrier signal to a level appropriate for transmission and deliver the modulated carrier signal to the antennas 112 through the antenna switching circuitry 110. The multiple antennas 112 and the replicated transmit 106 and receive circuitry 108 may provide spatial diversity. Modulation and processing details will be understood by those skilled in the art.

In an embodiment, the transmit circuitry 106 and the receive circuitry 108 can collectively function as the network access circuit 58 in FIG. 2, the network access circuit 58A in FIG. 3, the network access circuit 58B in FIG. 4, or the network access circuit 58C in FIG. 5. The antenna switching circuitry 110 and antennas 112 can collectively function as the radio access circuit 60 in FIG. 2, the radio access circuit 60A in FIG. 3, the radio access circuit 60B in FIG. 4, or the radio access circuit 60C in FIG. 5.

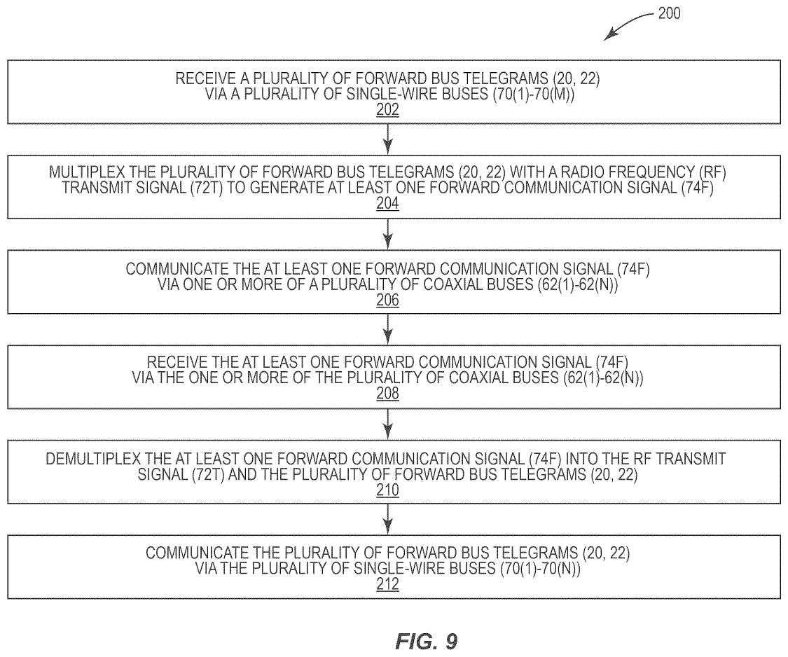

In an embodiment, it is possible to operate the multi-bus wireless communication system 56 of FIG. 2, the multi-bus wireless communication system 56A of FIG. 3, the multi-bus wireless communication system 56B of FIG. 4, the multi-bus wireless communication system 56C of FIG. 5, and the multi-bus wireless communication system 56D of FIG. 6 in accordance with a process. In this regard, FIG. 9 is a flowchart of an exemplary process 200 for operating the multi-bus wireless communication system 56 of FIG. 2, the multi-bus wireless communication system 56A of FIG. 3, the multi-bus wireless communication system 56B of FIG. 4, the multi-bus wireless communication system 56C of FIG. 5, and the multi-bus wireless communication system 56D of FIG. 6.

Herein, the process 200 includes receiving the forward bus telegrams 20, 22 via the single-wire buses 70(1)-70(M) (step 202). The process 200 also includes multiplexing the forward bus telegrams 20, 22 with the RF transmit signal 72T to generate the at least one forward communication signal 74F (step 204). The process 200 also includes communicating the at least one forward communication signal 74F via one or more of the coaxial buses 62(1)-62(N) (step 206). The process 200 also includes receiving the forward communication signal 74F via the one or more of the coaxial buses 62(1)-62(N) (step 208). The process 200 also includes demultiplexing the at least one forward communication signal 74F into the RF transmit signal 72T and the forward bus telegrams 20, 22 (step 210). The process 200 also includes communicating the forward bus telegrams 20, 22 via the single-wire buses 70(1)-70(N) (step 212).

Those skilled in the art will recognize improvements and modifications to the embodiments of the present disclosure. All such improvements and modifications are considered within the scope of the concepts disclosed herein and the claims that follow.

What is claimed is:

1. A multi-bus wireless communication system comprising:
a network access circuit coupled to a plurality of coaxial buses and comprising a plurality of single-wire buses, the network access circuit is configured to:
receive a plurality of forward bus telegrams via the plurality of single-wire buses;
multiplex the plurality of forward bus telegrams with a radio frequency (RF) transmit signal to generate at least one forward communication signal; and
communicate the at least one forward communication signal via one or more of the plurality of coaxial buses; and
a radio access circuit coupled to the plurality of coaxial buses and comprising the plurality of single-wire buses, the radio access circuit is configured to:
receive the at least one forward communication signal via the one or more of the plurality of coaxial buses;
demultiplex the at least one forward communication signal into the RF transmit signal and the plurality of forward bus telegrams; and
communicate the plurality of forward bus telegrams over the plurality of single-wire buses.

2. The multi-bus wireless communication system of claim 1, wherein:
the radio access circuit is further configured to:
receive a plurality of reverse bus telegrams via the plurality of single-wire buses, respectively;
multiplex the plurality of reverse bus telegrams with an RF receive signal to generate at least one reverse communication signal; and
communicate the at least one reverse communication signal to the network access circuit via the one or more of the plurality of coaxial buses; and
the network access circuit is further configured to:
receive the at least one reverse communication signal via the one or more of the plurality of coaxial buses;
demultiplex the at least one reverse communication signal into the RF receive signal and the plurality of reverse bus telegrams; and
communicate the plurality of reverse bus telegrams over the plurality of single-wire buses, respectively.

3. The multi-bus wireless communication system of claim 2, wherein:
the network access circuit further comprises:
a transceiver circuit configured to generate the RF transmit signal and receive the RF receive signal; and
a main circuit configured to generate the plurality of forward bus telegrams and receive the plurality of reverse bus telegrams; and
the radio access circuit further comprises a plurality of frontend subsystems configured to:
transmit the RF transmit signal and receive the RF receive signal; and
receive the plurality of forward bus telegrams and generate the plurality of reverse bus telegrams.

4. The multi-bus wireless communication system of claim 1, wherein:
the network access circuit further comprises a first subset of main multiplexer circuits and a second subset of main multiplexer circuits each coupled to a respective one of the plurality of coaxial buses and a respective one of the plurality of single-wire buses, wherein:
each of the first subset of main multiplexer circuits is configured to:
receive a respective one of the plurality of forward bus telegrams via the respective one of the plurality of single-wire buses;
multiplex the respective one of the plurality of forward bus telegrams with the RF transmit signal to thereby generate a respective one of a plurality of forward communication signals; and
communicate the respective one of the plurality of forward communication signals via the respective one of the plurality of coaxial buses; and
each of the second subset of main multiplexer circuits is configured to:
receive the respective one of the plurality of forward bus telegrams via the respective one of the plurality of single-wire buses;
generate the respective one of the plurality of forward communication signals comprising exclusively the respective one of the plurality of forward bus telegrams; and
communicate the respective one of the plurality of forward communication signals via the respective one of the plurality of coaxial buses; and
the radio access circuit comprises a first subset of subordinate multiplexer circuits and a second subset of subordinate multiplexer circuits each coupled to a respective one of the plurality of coaxial buses and a respective one of a plurality of embedded electronics via a respective one of the plurality of single-wire buses, wherein:
each of the first subset of subordinate multiplexer circuits is configured to:
receive the respective one of the plurality of forward communication signals via the respective one of the plurality of coaxial buses;
demultiplex the respective one of the plurality of forward bus telegrams into the RF transmit signal and the respective one of the plurality of forward bus telegrams; and
communicate the respective one of the plurality of forward bus telegrams to the respective one of the plurality of embedded electronics via the respective one of the plurality of single-wire buses;
each of the second subset of subordinate multiplexer circuits is configured to:
receive the respective one of the plurality of forward communication signals via the respective one of the plurality of coaxial buses;
demultiplex the respective one of the plurality of forward bus telegrams into the respective one of the plurality of forward bus telegrams; and
communicate the respective one of the plurality of forward bus telegrams to the respective one of the plurality of embedded electronics via the respective one of the plurality of single-wire buses.

5. The multi-bus wireless communication system of claim 4, wherein:
each of the first subset of subordinate multiplexer circuits and the second subset of subordinate multiplexer circuits is further configured to:
receive a respective one of a plurality of reverse bus telegrams from the respective one of the plurality of embedded electronics via the respective one of the plurality of single-wire buses;
multiplex the respective one of the plurality of reverse bus telegrams with an RF receive signal to generate a respective one of a plurality of reverse communication signals; and
communicate the respective one of the plurality of reverse communication signals via the respective one of the plurality of coaxial buses; and
each of the first subset of main multiplexer circuits is further configured to:
receive the respective one of the plurality of reverse bus telegrams via the respective one of the plurality of coaxial buses; and
demultiplex the respective one of the plurality of reverse bus telegrams into the RF receive signal and the respective one of the plurality of reverse bus telegrams; and
each of the second subset of main multiplexer circuits is further configured to:
receive the respective one of the plurality of reverse bus telegrams via the respective one of the plurality of coaxial buses; and
demultiplex the respective one of the plurality of reverse bus telegrams into the respective one of the plurality of reverse bus telegrams.

6. The multi-bus wireless communication system of claim 5, wherein:
the network access circuit further comprises:
a transceiver circuit configured to generate the RF transmit signal and receive the RF receive signal; and
a main circuit configured to generate the plurality of forward bus telegrams and receive the plurality of reverse bus telegrams; and
the radio access circuit further comprises:
a first subset of frontend subsystem each comprising a respective transmit-receive (TX/RX) antenna configure to transmit the RF transmit signal and receive the RF receive signal; and
a second subset of frontend subsystem each comprising a respective receive (RX) antenna configured to receive the RF receive signal.

7. The multi-bus wireless communication system of claim 4, wherein:
each of the first subset of main multiplexer circuits and the second subset of main multiplexer circuits is coupled to a respective main bias-T circuit and configured add direct-current (DC) power in the respective one of the plurality of forward communication signals; and
each of the first subset of subordinate multiplexer circuits and the second subset of subordinate multiplexer circuits is coupled to a respective subordinate bias-T circuit and configured receive the DC power from the respective one of the plurality of forward communication signals.

8. The multi-bus wireless communication system of claim 1, wherein:
the network access circuit further comprises a plurality of main multiplexer circuits each coupled to a respective one of the plurality of coaxial buses and a respective one of the plurality of single-wire buses, each of the plurality of main multiplexer circuits is configured to:
receive a respective one of the plurality of forward bus telegrams via the respective one of the plurality of single-wire buses;
multiplex the respective one of the plurality of forward bus telegrams with the RF transmit signal to thereby generate a respective one of a plurality of forward communication signals; and
communicate the respective one of the plurality of forward communication signals via the respective one of the plurality of coaxial buses; and
the radio access circuit comprises a plurality of subordinate multiplexer circuits each coupled to a respective one of the plurality of coaxial buses and at least two of a plurality of embedded electronics via a respective one of the plurality of single-wire buses, each of the plurality of subordinate multiplexer circuits is configured to:
receive the respective one of the plurality of forward communication signals via the respective one of the plurality of coaxial buses;
demultiplex the respective one of the plurality of forward bus telegrams into the RF transmit signal and the respective one of the plurality of forward bus telegrams; and
communicate the respective one of the plurality of forward bus telegrams to each of the at least two of the plurality of embedded electronics via the respective one of the plurality of single-wire buses.

9. The multi-bus wireless communication system of claim 8, wherein:
each of the plurality of subordinate multiplexer circuits is further configured to:
receive a respective one of a plurality of reverse bus telegrams from each of the at least two of the plurality of embedded electronics via the respective one of the plurality of single-wire buses;
multiplex the respective one of the plurality of reverse bus telegrams with an RF receive signal to generate a respective one of a plurality of reverse communication signals; and
communicate the respective one of the plurality of reverse communication signals via the respective one of the plurality of coaxial buses; and
each of the plurality of main multiplexer circuits is further configured to:
receive the respective one of the plurality of reverse bus telegrams via the respective one of the plurality of coaxial buses; and
demultiplex the respective one of the plurality of reverse bus telegrams into the RF receive signal and the respective one of the plurality of reverse bus telegrams.

10. The multi-bus wireless communication system of claim 9, wherein:
the network access circuit further comprises:
a transceiver circuit configured to generate the RF transmit signal and receive the RF receive signal; and
a main circuit configured to generate the plurality of forward bus telegrams and receive the plurality of reverse bus telegrams; and
the radio access circuit further comprises:
a first subset of frontend subsystems each comprising a respective transmit-receive (TX/RX) antenna configure to transmit the RF transmit signal and receive the RF receive signal; and
a second subset of frontend subsystems each comprising a respective receive (RX) antenna configured to receive the RF receive signal.

11. The multi-bus wireless communication system of claim 10, wherein:
each of the plurality of subordinate multiplexer circuits is further configured to multiplex the respective one of the plurality of reverse bus telegrams with the RF receive signal received by the first subset of frontend subsystems to generate a respective one of the plurality of reverse communication signals; and
the transceiver circuit is further configured to receive the RF receive signal directly from the second subset of frontend subsystems.

12. The multi-bus wireless communication system of claim 8, wherein:
each of the plurality of main multiplexer circuits is coupled to a respective main bias-T circuit and configured add direct-current (DC) power in the respective one of the plurality of forward communication signals; and
each of the plurality of subordinate multiplexer circuits is coupled to a respective subordinate bias-T circuit and configured receive the DC power from the respective one of the plurality of forward communication signals.

13. The multi-bus wireless communication system of claim 1, wherein:
the network access circuit further comprises a plurality of main multiplexer circuits each coupled to a respective one of the plurality of coaxial buses and a respective one of the plurality of single-wire buses, each of the plurality of main multiplexer circuits is configured to:
receive a respective one of the plurality of forward bus telegrams via the respective one of the plurality of single-wire buses;
multiplex the respective one of the plurality of forward bus telegrams with the RF transmit signal to thereby generate a respective one of a plurality of forward communication signals; and
communicate the respective one of the plurality of forward communication signals via the respective one of the plurality of coaxial buses; and
the radio access circuit comprises a plurality of subordinate multiplexer circuits each coupled to a respective one of the plurality of coaxial buses and at least two of a plurality of embedded electronics via a respective one of the plurality of single-wire buses, each of the plurality of subordinate multiplexer circuits is configured to:
receive the respective one of the plurality of forward communication signals via the respective one of the plurality of coaxial buses;
demultiplex the respective one of the plurality of forward bus telegrams into the RF transmit signal and the respective one of the plurality of forward bus telegrams; and
communicate the respective one of the plurality of forward bus telegrams to each of the at least two of the plurality of embedded electronics via the respective one of the plurality of single-wire buses.

14. The multi-bus wireless communication system of claim 13, wherein:
each of the plurality of subordinate multiplexer circuits is further configured to:
receive a respective one of a plurality of reverse bus telegrams from each of the at least two of the plurality of embedded electronics via the respective one of the plurality of single-wire buses;
multiplex the respective one of the plurality of reverse bus telegrams with an RF receive signal to generate a respective one of a plurality of reverse communication signals; and
communicate the respective one of the plurality of reverse communication signals via the respective one of the plurality of coaxial buses; and
each of the plurality of main multiplexer circuits is further configured to:
receive the respective one of the plurality of reverse bus telegrams via the respective one of the plurality of coaxial buses; and
demultiplex the respective one of the plurality of reverse bus telegrams into the RF receive signal and the respective one of the plurality of reverse bus telegrams.

15. The multi-bus wireless communication system of claim 14, wherein:
the network access circuit further comprises:
a transceiver circuit configured to generate the RF transmit signal and receive the RF receive signal; and
a main circuit configured to generate the plurality of forward bus telegrams and receive the plurality of reverse bus telegrams; and
the radio access circuit further comprises:
a first subset of frontend subsystems each comprising a respective transmit-receive (TX/RX) antenna configured to transmit the RF transmit signal and receive the RF receive signal; and
a second subset of frontend subsystems each comprising a respective receive (RX) antenna configured to receive the RF receive signal.

16. The multi-bus wireless communication system of claim 15, wherein each of the plurality of subordinate multiplexer circuits is further configured to multiplex the respective one of the plurality of reverse bus telegrams with the RF receive signal received by the first subset of frontend subsystems to generate a respective one of the plurality of reverse communication signals.

17. The multi-bus wireless communication system of claim 15, wherein:
the radio access circuit further comprises a plurality of subordinate bias-T networks each coupled to the respective one of the plurality of coaxial buses and configured to:
receive the RF receive signal directly from the second subset of frontend subsystems;
generate the respective one of the plurality of reverse communication signals comprising exclusively the RF receive signal; and
communicate the respective one of the plurality of reverse communication signals via the respective one of the plurality of coaxial buses; and
the network access circuit further comprises a plurality of main bias-T networks each coupled to the respective one of the plurality of coaxial buses and configured to:
receive the respective one of the plurality of reverse communications signals via the respective one of the plurality of coaxial buses; and
extract the RF receive signal from the respective one of the plurality of reverse communication signals.

18. The multi-bus wireless communication system of claim 17, wherein:
each of the plurality of main bias-T networks is further configured to provide direct-current (DC) power via the respective one of the plurality of coaxial buses; and
each of the plurality of subordinate bias-T networks is further configured to receive the DC power via the respective one of the plurality of coaxial buses.

19. A vehicular wireless communication system comprising a multi-bus wireless communication system, the multi-bus wireless communication system comprises:
a network access circuit coupled to a plurality of coaxial buses and comprising a plurality of single-wire buses, the network access circuit is configured to:
receive a plurality of forward bus telegrams via the plurality of single-wire buses;
multiplex the plurality of forward bus telegrams with a radio frequency (RF) transmit signal to generate at least one forward communication signal; and
communicate the at least one forward communication signal via one or more of the plurality of coaxial buses; and
a radio access circuit coupled to the plurality of coaxial buses and comprising the plurality of single-wire buses, the radio access circuit is configured to:
receive the at least one forward communication signal via the one or more of the plurality of coaxial buses;
demultiplex the at least one forward communication signal into the RF transmit signal and the plurality of forward bus telegrams; and
communicate the plurality of forward bus telegrams over the plurality of single-wire buses.

20. A method for operating a multi-bus wireless communication system comprising:
receiving a plurality of forward bus telegrams via a plurality of single-wire buses;
multiplexing the plurality of forward bus telegrams with a radio frequency (RF) transmit signal to generate at least one forward communication signal;
communicating the at least one forward communication signal via one or more of a plurality of coaxial buses;
receiving the at least one forward communication signal via the one or more of the plurality of coaxial buses;
demultiplexing the at least one forward communication signal into the RF transmit signal and the plurality of forward bus telegrams; and
communicating the plurality of forward bus telegrams over the plurality of single-wire buses.
